(19) United States
(12) Patent Application Publication
(10) Pub. No.: US 2026/0042614 A1
(43) Pub. Date: Feb. 12, 2026

(54) SYSTEM AND METHOD FOR CONTINUAL MONITORING OF A MODULAR CONVEYOR BELT

(71) Applicant: Habasit Italiana S.p.A., Cesano Boscone (Milano) (IT)

(72) Inventor: Klaus WAGNER, Reinach (CH)

(21) Appl. No.: 18/797,498

(22) Filed: Aug. 7, 2024

(51) Int. Cl. B65G 43/02

(52) U.S. Cl. CPC B65G 43/02; B65G 2203/0275; B65G 2203/044

(57) ABSTRACT

The present disclosure may be embodied as a system for monitoring a belt. The system includes a sensor configured to be mounted near a belt. The sensor is configured to detect a profile of the belt. A processor is in electronic communication with the sensor. The processor is programmed to receive an electrical signal from the sensor; detect a repeating pattern in the electrical signal; and detect a deviation from the repeating pattern. In some embodiments, detecting a deviation from the repeating pattern further includes calculating a rolling average profile. The rolling average profile may, for example, an average of the most recent 5-100 cycles of the repeating pattern. In some embodiments, the deviation from the repeating pattern exceeds a predetermined deviation threshold for a duration of a cycle of the repeating pattern.

### FIELD OF THE DISCLOSURE

The present disclosure relates to modular conveyor belts, and more particularly for techniques to detect problem conditions in modular conveyor belts.

### BACKGROUND OF THE DISCLOSURE

Conveyor belts, such as modular conveyor belts are commonly used in various industries. The integrity and proper functioning of such conveyor belts are crucial for maintaining operational efficiency, preventing downtime, etc. Belt maintenance is often performed on a scheduled basis and/or in response to visible wear or failure. However, this approach can lead to unexpected breakdowns, causing costly production interruptions and potential safety hazards. There is a growing need for a robust, reliable, and cost-effective system that can continuously monitor the condition of moving conveyor belts, detect potential issues before they lead to failures, and provide actionable insights for maintenance planning.

### BRIEF SUMMARY OF THE DISCLOSURE

The present disclosure may be embodied as a system for monitoring a belt. The system includes a sensor configured to be mounted near a belt. For example, the sensor may be configured to be located at a position wherein the belt is fully expanded. For example, the sensor may be configured to be located at an outer edge of a radius belt. The sensor is configured to detect a profile of the belt. The sensor may be, for example, an optical sensor, a laser sensor, a lidar sensor, a radar sensor, an ultrasound sensor, a capacitive sensor, an eddy current sensor, a time-of-flight sensor, a magnetic flux leakage sensor, a 3D structured light sensor, or a confocal chromatic sensor, or other sensors, or combinations of such sensors.

A processor is in electronic communication with the sensor. The processor is programmed to receive an electrical signal from the sensor: detect a repeating pattern in the electrical signal; and detect a deviation from the repeating pattern. In some embodiments, detecting a deviation from the repeating pattern further includes calculating a rolling average profile. The rolling average profile may, for example, an average of the most recent 5-100 cycles of the repeating pattern. In some embodiments, the deviation from the repeating pattern exceeds a predetermined deviation threshold for a duration of a cycle of the repeating pattern.

The processor may be further programmed to trigger an alarm when a deviation is detected. The processor may be further programmed to flag a location of the belt corresponding to the deviation. The processor may be configured to stop the belt when the flagged location is at a repair station. The processor may be further programmed to mark the flagged location using a printer.

The system may further include a communications interface and wherein the processor may be further programmed to send a report of a deviation via the communications interface. For example, the communications interface may be a serial interface, a wireless interface, a network interface, an SMS interface, or an email interface.

In another aspect the present disclosure may be embodied as a method for monitoring a modular conveyor belt. The method includes receiving a measurement signal from a sensor configured to detect a profile of a modular conveyor belt. The method includes detecting a repeating pattern in the electrical signal and detecting a deviation from the repeating pattern. The step of detecting a deviation from the repeating pattern may further include calculating a rolling average profile.

In some embodiments, the method includes flagging a location of the conveyor belt corresponding to the deviation. The method may include stopping the conveyor belt when the flagged location is at a repair station. The method may include marking the flagged location using a printer. The method may include triggering an alarm when a deviation is detected. The method may include sending a report of a deviation via a communications interface, such as, for example, a serial interface, a wireless interface, a network interface, an SMS interface, or an email interface.

### DESCRIPTION OF THE DRAWINGS

For a fuller understanding of the nature and objects of the disclosure, reference should be made to the following detailed description taken in conjunction with the accompanying drawings, in which:

FIG. 1 is a diagram depicting a system according to an embodiment of the present disclosure.

FIG. 2 is a cross-sectional view of a modular conveyor belt showing various sensor positions adjacent to an edge of the conveyor belt.

FIG. 3 depicts a method according to another embodiment of the present disclosure.

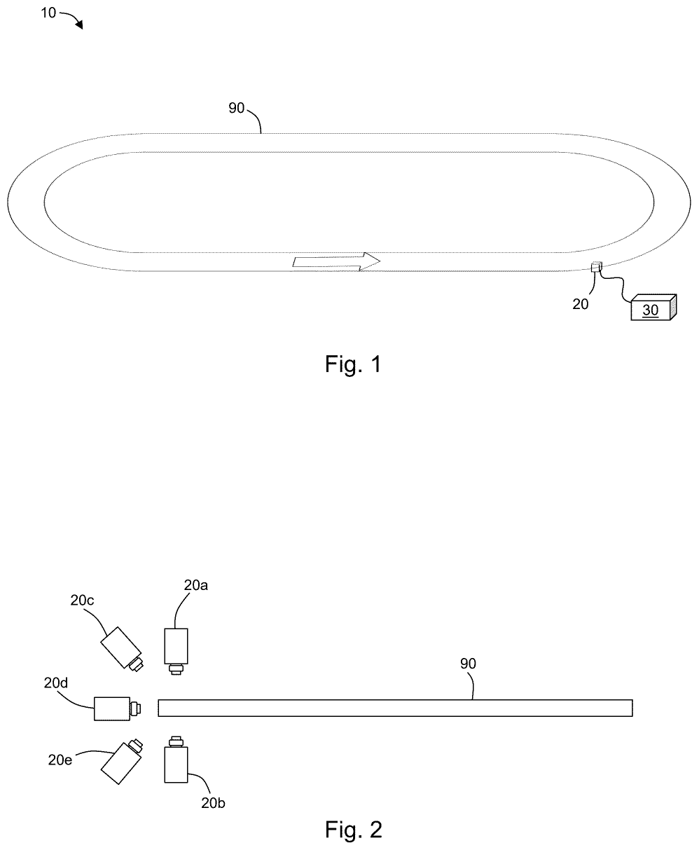

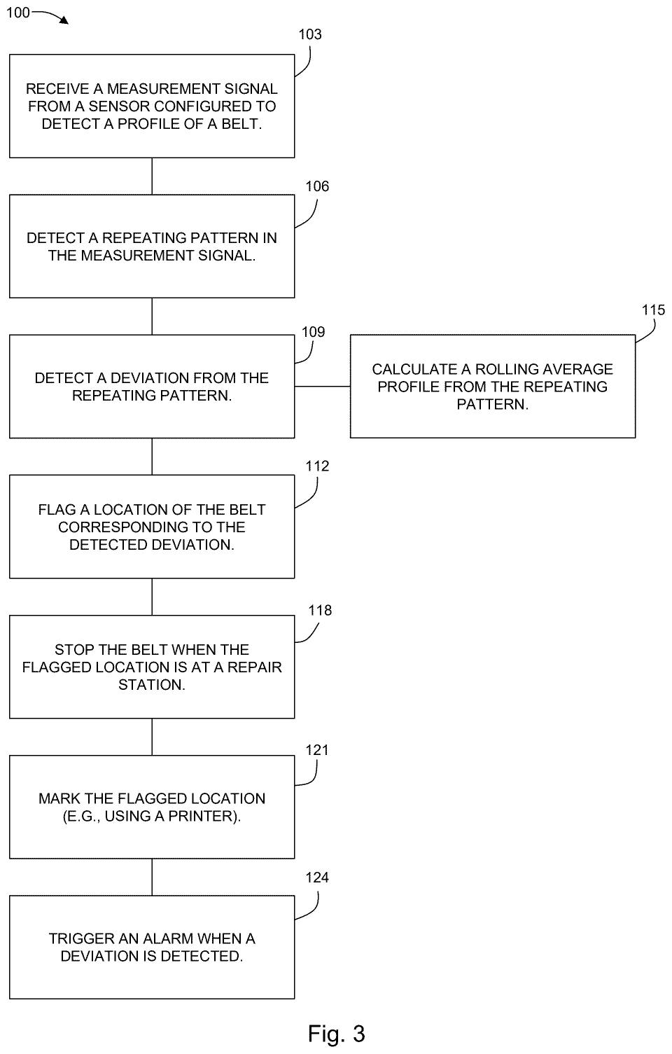

### DETAILED DESCRIPTION OF THE DISCLOSURE

In a first aspect, the present disclosure may be embodied as a system 10 for monitoring a belt 90, such as, for example, a modular conveyor belt or a timing belt. The system 10 includes a sensor 20 configured to be mounted near the belt 90. The sensor is capable of capturing detailed information about the belt's structure as it advances past the sensor. For example, the sensor may be an optical sensor, a laser sensor, an acoustic sensor (e.g., an ultrasound sensor), a LiDAR sensor, a radar sensor, a capacitive sensor, an eddy current sensor, a time-of-flight sensor, a magnetic flux leakage sensor, a 3D structured light sensor, or a confocal chromatic sensor etc.

The sensor is positioned adjacent the belt and oriented to detect an edge of the belt where large forces are applied. In this way, the sensor captures a physical characteristic of the belt when the belt is maximally extended. For example, the sensor may be positioned so as to capture the belt at an outside edge of a radius curve of a modular conveyor belt. This placement allows the sensor to capture real-time data as the belt moves, allowing for the detection of both regular patterns of the belt and deviations from such regular patterns. The sensor may be positioned above 20a, below 20b, or beside 20c, 20d, 20e the belt (see non-limiting examples depicted in FIG. 2), including positions between those depicted in the figure and other positions along the belt width.

As the belt moves past the sensor, the sensor detects a profile of the belt (i.e., at least a portion of the belt). The detection may occur at a sampling frequency such that the sensor continually samples the profile of the belt (e.g., a portion of the belt such as, for example, an edge portion, a center rib, hinge structures, or the like). For example, the sensor may capture repeated patterns present in the regular structure of the belt. These patterns serve as a baseline for comparison, allowing the system to establish a reference profile for a well-performing belt. The sampling frequency is preferably at least double the rate as the modules of the belt passing the sensor, but may be higher, such as for example, three times the frequency of the belt modules, 4×, 5×, 10×, or more or values between these.

A processor 30 is in electronic communication with the sensor 20. The processor is programmed to receive an electronic signal from the sensor. The electronic signal represents the modular conveyor belt profile detected by the sensor. The processor is programmed to detect a repeating pattern in the received electrical signal. The repeating profile corresponds to a repeating profile of the belt as the belt modules move past the sensor in a generally constant, repeating manner. The processor may detect the repeating pattern in real-time.

The processor is programmed to detect a deviation from the repeated pattern. In an example, where a hinge pin of the conveyor belt has broken, the belt modules may have increased spacing, and the processor may detect this deviation in spacing as compared to the repeating pattern. In some embodiments, the processor may calculate a rolling average profile of the conveyor belt based on the detected repeating pattern. For example, the rolling average profile may be an average of the most recent 5-100 cycles of the repeating pattern. A deviation from this rolling average (e.g., a deviation of a characteristics such as, for example, belt module spacing) may be detected. In embodiments where the deviation may be detected as a change in a measured property, a deviation may be determined based on a threshold difference of 5%, 10%, 15%, 20%, (or other threshold values between these values or greater than these values) between the deviation and the repeating pattern. The threshold may be a predetermined threshold. The deviations detected may be caused by acute conditions (e.g., a broken hinge pin, broken belt module, etc.) or may be caused by wear conditions.

The processor is programmed to flag a location of the belt when the deviation exceeds predetermined limit. By flagging, the processor may track in memory the location of the deviation. For example, the processor may determine a distance of the deviation from the sensor based on the belt speed and track this distance as the conveyor belt advances.

In some embodiments, the processor may use machine learning to detect a deviation in the detected profile of the belt. For example, a neural network, such as, for example, an autoencoder, a convolutional neural network, a recurrent neural network (such as a Long Short-Term Memory (LSTM) network), or a transformer, may be trained to detect a deviation from a repeating pattern. Other types of machine learning may be suitable and are within the scope of the present disclosure.

The detection modality will depend on the sensor type and detection type. For example, an optical sensor in the form of a camera may be used to repeatedly sample a portion of a belt. Such a modality may be suitable for object recognition and measurement algorithms to detect deviations in the physical measurements. Such a modality may also be suited to detecting deviation using machine learning, for example, by analyzing the images capture by the camera. In another example, a lidar sensor may be used to measure a physical profile of a portion of a belt. Such profile measurements may be quickly analyzed by a processor using traditional algorithms to detect deviations (though machine learning may be used as an alternative to (or in addition to) such traditional algorithms).

Once the deviation location has been flagged, the processor may be further programmed to take further action. For example, in some embodiments, the processor may be programmed to trigger an alarm (e.g., a buzzer, siren, bell, light, etc.) In another example, the processor may advance a conveyor belt such that the flagged location is moved to a repair station, and the conveyor belt can be stopped. In this way, a service person may see the irregularity in the belt and take corrective action. Such a repair station may be stocked with the proper tools and replacement parts for expeditious resolution of the deviation.

In another example, the processor may be programmed to mark the flagged location using a printer or other marking technique (spray paint, marking pen, etc.) For example, the system may be in communication with a printer or may include a printer, and the processor may send instructions to the printer (e.g., stop the belt when the flagged location is located at a known printer location and instruct the printer to mark the belt). The system may provide users with a visualization to interpret the detected irregularities. The specific locations(s) of the belt where a failure has been detected can be located, for example, using a LED traffic light signalization. This allows operators to easily assess the severity of the problem.

In some embodiments, the processor is programmed to notify maintenance personnel. For example, the system may interface with a maintenance system to engage personnel, trigger repair/replacement, update maintenance logs, etc. The system may interface with a cloud-based system or local system. In some embodiments, notifications may be sent through interfaces such as, for example, short messaging service (SMS) or an email, to notify appropriate personnel. Such a system allows for timely intervention and minimized downtime. The system may include a communications interface and the processor may be programmed to send a report of a deviation via the communications interface. Non-limiting examples of a communications interface include a serial interface, a wireless interface, a network interface, an SMS interface, or an email interface.

The processor may be in communication with and/or may include a memory. The memory can be, for example, a random-access memory (RAM) (e.g., a dynamic RAM, a static RAM), a flash memory, a removable memory, and/or so forth. In some instances, instructions associated with performing the operations described herein (e.g., image processing, machine learning, etc.) can be stored within the memory and/or a storage medium (which, in some embodiments, includes a database in which the instructions are stored) and the instructions are executed at the processor.

In some instances, the processor includes one or more modules and/or components. Each module/component executed by the processor can be any combination of hardware-based module/component (e.g., a field-programmable gate array (FPGA), an application specific integrated circuit (ASIC), a digital signal processor (DSP)), software-based module (e.g., a module of computer code stored in the memory and/or in the database, and/or executed at the processor), and/or a combination of hardware- and software-based modules. Each module/component executed by the processor is capable of performing one or more specific functions/operations as described herein. In some instances, the modules/components included and executed in the processor can be, for example, a process, application, virtual machine, and/or some other hardware or software module/component. The processor can be any suitable processor configured to run and/or execute such modules/components. The processor can be any suitable processing device configured to run and/or execute a set of instructions or code. For example, the processor can be a general-purpose processor, a central processing unit (CPU), an accelerated processing unit (APU), a field-programmable gate array (FPGA), an application specific integrated circuit (ASIC), a digital signal processor (DSP), and/or the like.

In another aspect, the present disclosure may be embodied as a method 100 for monitoring a belt, such as, for example, a modular conveyor belt or a timing belt. The method 100 includes receiving 103 a measurement signal from a sensor configured to detect a profile of a belt. A repeating pattern is detected 106 in the measurement signal. A deviation is detected 109 from the repeating pattern. In some embodiments, the deviation is detected by calculating 115 a rolling average profile from the repeating pattern. For example, the rolling average profile may be an average of the most recent 5-100 cycles of the repeating pattern. A deviation from this rolling average (e.g., a deviation of a characteristics such as, for example, belt module spacing) may be detected. In embodiments where the deviation may be detected as a change in a measured property, a deviation may be determined based on a threshold difference of 5%, 10%, 15%, 20%, (or other threshold values between these values or greater than these values) between the deviation and the repeating pattern. The threshold may be a predetermined threshold. In some embodiments, an alarm may be triggered 124 when a deviation is detected (e.g., a buzzer, siren, bell, light, etc.)

The method includes flagging 112 a location of the belt corresponding to the detected 109 deviation. The method may include stopping 118 the belt when the flagged location is at a repair station. In this way, a service person may see the irregularity in the belt and take corrective action. Such a repair station may be stocked with the proper tools and replacement parts for expeditious resolution of the deviation. By flagging, the location of the deviation on the belt may be tracked (recorded)—e.g., in a memory. For example, a distance of the deviation from the sensor may be determined based on the belt speed and this distance may be tracked as the belt advances.

The flagged location may be marked 121, for example, using spray paint, marking pen, etc. In some embodiments, the flagged location is marked using a printer. A visualization may be provided to interpret the detected irregularities. The specific locations(s) of the belt where a failure has been detected can be located, for example, using a LED traffic light signalization. This allows operators to easily assess the severity of the problem.

The method may include sending a report of a deviation via a communications interface. Non-limiting examples of a communications interface include a serial interface, a wireless interface, a network interface, an SMS interface, or an email interface.

As used herein, the term “near” refers to a spatial relationship between two or more objects, components (e.g., belt and sensor), or locations, where the distance separating them is sufficiently small to allow for functional interaction, communication, or influence between the objects, components, or locations within the context of the described invention. The precise distance denoted by “near” may vary depending on the specific application, scale, and requirements of the application, and should be interpreted in light of the particular embodiment being described. In some instances, “near” may indicate direct physical contact or adjacency, while in others it may encompass distances up to several times the characteristic dimension of the objects or components involved. The sensor may be positioned at a distance from the belt that allows for accurate and reliable detection of the belt's physical location (e.g., distance to the belt) as it passes the sensor's location. The distance between the sensor and the belt may be sufficiently close to enable the sensor to operate within its specified detection range and sensitivity. The sensor may be placed close enough to the belt to minimize interference from other objects or environmental factors that could affect the accuracy of the measurements. The distance may be far enough to avoid physical contact between the sensor and the belt during normal operation, accounting for any expected lateral movement or vibration of the belt. The specific distance denoted by “near” may vary depending on factors such as the type and capabilities of the sensor, the speed and characteristics of the moving belt, and the required precision of the measurements. For example, this distance may range from a few millimeters or less, to several centimeters, but may extend further depending on the specific application and sensor technology employed. For example, the distance may range from <1 mm, 1 mm, 2 mm, 3 mm, 4 mm, 5 mm, 1 cm, 2 cm, 3 cm, 4 cm, 5 cm, 10 cm, 15 cm, 20 cm, 25 cm, 30 cm, or more, or any value between such values to the nearest mm.

The term “profile” as used herein may refer to any measured characteristic of a belt, and which characteristic may vary in a repeating pattern as the belt moves past a fixed location (e.g., a location of a sensor). For example, a profile may refer to a belt position, thickness, elevation, edge shape, optical property (e.g., color, transparency, reflectivity, etc.), material type (magnetic, metallic, etc.), or other characteristic or combinations of such characteristics.

Although the present disclosure has been described with respect to one or more particular embodiments, it will be understood that other embodiments of the present disclosure may be made without departing from the spirit and scope of the present disclosure.

What is claimed is:

1. A system for monitoring a belt, comprising:
a sensor configured to be mounted near a belt, the sensor configured to detect a profile of the belt; and
a processor in electronic communication with the sensor, the processor being programmed to:
receive an electrical signal from the sensor;
detect a repeating pattern in the electrical signal; and
detect a deviation from the repeating pattern.

2. The system of claim 1, wherein detecting a deviation from the repeating pattern further comprises calculating a rolling average profile.

3. The system of claim 2, wherein the rolling average profile is an average of the most recent 5-100 cycles of the repeating pattern.

4. The system of claim 1, wherein the deviation from the repeating pattern exceeds a predetermined deviation threshold for a duration of a cycle of the repeating pattern.

5. The system of claim 1, wherein the sensor is an optical sensor, a laser sensor, a lidar sensor, a radar sensor, an ultrasound sensor, a capacitive sensor, an eddy current sensor, a time-of-flight sensor, a magnetic flux leakage sensor, a 3D structured light sensor, or a confocal chromatic sensor.

6. The system of claim 1, wherein the sensor is configured to be located at a position wherein the belt is fully expanded.

7. The system of claim 1, wherein the sensor is configured to be located at an outer edge of a radius belt.

8. The system of claim 1, wherein the processor is further programmed to trigger an alarm when a deviation is detected.

9. The system of claim 1, wherein the processor is further programmed to flag a location of the belt corresponding to the deviation.

10. The system of claim 9, wherein the processor is configured to stop the belt when the flagged location is at a repair station.

11. The system of claim 9, wherein the processor is further programmed to mark the flagged location using a printer.

12. The system of claim 1, further comprising a communications interface and wherein the processor is further programmed to send a report of a deviation via the communications interface.

13. The system of claim 12, wherein the communications interface is a serial interface, a wireless interface, a network interface, an SMS interface, or an email interface.

14. A method for monitoring a modular conveyor belt, comprising:
receiving a measurement signal from a sensor configured to detect a profile of a modular conveyor belt; and
detecting a repeating pattern in the electrical signal; and
detecting a deviation from the repeating pattern.

15. The method of claim 14, wherein detecting a deviation from the repeating pattern further comprises calculating a rolling average profile.

16. The method of claim 14, further comprising flagging a location of the conveyor belt corresponding to the deviation.

17. The method of claim 16, further comprising stopping the conveyor belt when the flagged location is at a repair station.

18. The method of claim 16, further comprising marking the flagged location using a printer.

19. The method of claim 14, further comprising triggering an alarm when a deviation is detected.

20. The method of claim 14, further comprising sending a report of a deviation via a communications interface.

21. The method of claim 20, wherein the communications interface is a serial interface, a wireless interface, a network interface, an SMS interface, or an email interface.
